(19) United States
(12) Patent Application Publication
(10) Pub. No.: US 2022/0052548 A1
(43) Pub. Date: Feb. 17, 2022

(54) EMERGENCY POWER SUPPLY FOR AN ELEVATOR CABIN

(71) Applicant: TK Elevator Innovation and Operations GmbH, Duesseldorf (DE)

(72) Inventors: Sergio Roth, Porto Alegre (BR); Christopher PIMENTEL, Guaíba (BR); Christian SASSO, Porto Alegre (BR)

(73) Assignee: TK Elevator Innovation and Operations GmbH, Duesseldorf (DE)

(21) Appl. No.: 17/310,052

(22) PCT Filed: Jan. 21, 2019
(86) PCT No.: PCT/EP2019/051319

§ 371 Date: Jul. 14, 2021

(51) Int. Cl. H02J 9/06; B66B 5/00; B66B 5/02

(52) U.S. Cl. CPC H02J 9/06; B66B 5/028; B66B 5/0087

(57) ABSTRACT

A method of operating an emergency power supply for an elevator cabin includes determining a remaining power supply capacity of an energy storage device of the emergency power supply, determining a power demand of an electrical consumer, and predicting how long the energy storage device is capable of providing the electrical consumer with power, based on the determined remaining power supply capacity and the determined power demand. An emergency power supply for an elevator cabin includes an energy storage device configured to provide emergency power to an electrical consumer in the elevator cabin, and a control unit. The control unit is configured to control operation of the energy storage device, determine a remaining power supply capacity of the energy storage device, determine a power demand of the electrical consumer, and predict an amount of time for which the energy storage device is able to power the electrical consumer.

The invention relates to a method of operating an emergency power supply for at least one electrical consumer in an elevator, as well as to an emergency power supply. Furthermore, the invention relates to an elevator and an elevator cabin comprising such an emergency power supply.

Elevators—at least elevators for lifting people—typically comprise an emergency power supply for situations in which the main power source of the elevator fails. Emergency power supplies often comprise a battery as an energy storage device that can provide lighting, communication and even air-conditioning during such power failures.

Nevertheless, using its battery, the emergency power supply can only keep these emergency functions running for limited amount of time. Typically, emergency functions cease to be carried out once certain current and/or voltage thresholds can no longer be supplied by the battery.

However, for a passenger traveling in an elevator cabin, it might be very uncomfortable to be left without emergency power, i.e. in the dark and without the possibility of communication. Therefore, emergency power supplies are designed in a way that they provide emergency power over a time period long enough for emergency assistance to normally arrive at the elevator site and free the passenger.

That is why in various national and international standards, certain time period thresholds are stated as requirements for emergency power supplies for elevators. An exemplary requirement of such a standard is the following: lighting and communication must be provided for at least one hour from the beginning of the main power failure, regardless of any environmental or elevator system conditions. During this one hour, emergency assistance is typically able to adequately respond.

With battery capacity degrading over a lifetime and with the huge variety of environmental conditions that elevators are used in, it often proves difficult for maintenance staff to decide on whether the installed emergency power supply will still be able meet the relevant standards' requirements under all conditions.

In JP-H-09227050, a remaining capacity measuring apparatus for a battery for elevator emergency power supply apparatus is disclosed for accurately determining battery remaining capacity. To achieve this objective, a terminal voltage, a discharge current, and a temperature of the battery are detected, when the battery is charged for a short time, and the remaining capacity of the battery is judged from each of the detected values. The disclosed apparatus aims at determining a remaining battery lifetime. This method and apparatus do not take operational or environmental conditions of the elevator cabin into account.

Therefore, an objective of the invention is to provide better emergency power supply in an elevator cabin.

This task is solved by a method of operating an emergency power supply comprising the features of claim one and an emergency power supply comprising the features of claim 9. An elevator cabin is subject of claim 13; an elevator subject of claim 15. Dependent claims are directed towards advantageous embodiments of the invention.

According to one aspect, the invention provides a method of operating an emergency power supply for at least one, particularly more, electrical consumers in an elevator cabin, wherein a remaining power supply capacity of an energy storage device of the emergency power supply is determined.

A, particularly real time, power demand of the electrical consumer is determined, particularly during a test time interval. Particularly, the test time interval is a part of a second or several seconds or several minutes.

Based on the determined power supply capacity and the determined power demand, a period of time in which the energy storage device is capable of providing the electrical consumer(s) with power is predicted. In this context, the term “period of time” particularly refers to the time span between a failure of the elevator's main power source and an inability of the emergency power supply to provide emergency power to the electrical consumer(s).

In order to make sure standardization requirements can be adhered to, according to an embodiment, the predicted period of time is then compared to a predetermined time period threshold, which can be a corporate, national or international standardization requirement, for example one or several hours.

To provide the necessary information to maintenance staff or maintenance facility, according to an embodiment, an information representative of the result of the comparison is provided in the elevator cabin and/or at the elevator lobby and/or to a cloud storage and/or to maintenance staff and/or to a maintenance facility.

According to another aspect, the invention provides an emergency power supply (device) for at least one electrical consumer in an elevator cabin, particularly configured to operate by a method according to an embodiment of the first aspect of the invention.

The emergency power supply at least comprises an energy storage device for providing power to the electrical consumer during a failure of the elevator main power supply, and a control unit for the operation of the energy storage device, wherein the control unit is configured to determine a remaining power supply capacity of the energy storage device.

The control unit is configured to determine a, particularly real time, power demand of the electrical consumer.

The control unit is configured to, based on the determined power supply capacity and the determined power demand, predict a period of time in which the energy storage device is capable of providing the electrical consumer with power.

According to another aspect, the invention provides an elevator cabin for use in an elevator, comprising an emergency power supply according to an embodiment of the invention.

Particularly, the elevator cabin comprises at least one electrical consumer, particularly a cabin lighting and/or an emergency communication device and/or an emergency air conditioning.

According to another aspect, the invention provides an elevator (system) comprising at least one elevator cabin according to an embodiment of the invention.

The invention is based on the finding that the variety of field and operation environments in which elevator systems are installed make it difficult for the maintenance technician in the field to decide whether a costly battery change for the emergency power supply, in order to meet standardization requirements with respect to the period of time with available emergency power, is or is not yet necessary.

To answer that question better than in known emergency power supplies, the invention offers the idea of taking into account not only the actual remaining battery capacity, but also the actual power consumption of the electrical consumers (for example lighting, intercom, etc.).

By determining the available amount of energy (remaining battery capacity) and the probable or potential energy drain during a main power failure (power consumption of the electrical consumers), a very good estimate of the available emergency power time period becomes possible.

The prediction of the period of time during which the energy storage device will be capable of providing the electrical consumer(s) with sufficient emergency power greatly reduces the time and effort a maintenance technician will have to invest for reliably judging whether the battery will have to be changed or not.

In order to provide the information on whether to change the energy storage device or not in a way suitable for the situation, according to different embodiments, the information is provided via visual, audible and/or textual message, particularly in case the time period threshold exceeds the predicted period of time. In an exemplary embodiment, the information can be provided using an LED or an LED display in the cabin in combination with suitable lighting or text pattern, and/or speakers in combination with suitable sounds or voice generation.

According to an embodiment, the power demand of the electrical consumer(s) is determined based on a power consumption and/or a development of the power consumption of the electrical consumer during a test interval.

The term “electrical consumer” particularly comprises devices that have to continue working during a predetermined time period once a main power failure occurs, especially since they are essential for elevator passenger safety/comfort and/or standardization requirement.

Examples for electrical consumers are amongst others a cabin lighting, a communication device, or an air conditioning device.

The term “power demand” particularly refers to the electrical energy and/or electrical energy per time unit, which is required by an electrical consumer to perform proper function.

The term “power consumption” particularly refers to an amount of electrical energy an electrical consumer requires during a test interval.

The term “test interval” particularly refers to a time span used for performing a test, especially a test of the power consumption and/or a power demand of an electrical consumer.

According to an embodiment, for proper consideration of environmental operating conditions of the elevator, the power demand is determined based on at least one value of at least one environmental parameter, which is particularly representative of an environmental situation of the elevator cabin or of the elevator. An environmental parameter can particularly be a shaft or a cabin temperature of the elevator, or an air humidity in the shaft or in the cabin. In an exemplary embodiment, the power consumption of an air conditioning system as an electrical consumer might be higher at a higher temperature and lower at a lower temperature.

According to an embodiment, the remaining power supply capacity is determined based on at least one value of a parameter representative of a charge level of the energy storage device and/or based on at least one value of a degradation parameter representative of a degradation level of the energy storage device and/or based on at least one value of an environmental parameter representative of an environmental situation of the elevator cabin or of the elevator system.

There is an influence of a charge level of the energy storage device on the remaining power capacity.

However, considering a degradation parameter allows for taking aging effects, for example of a battery-based energy storage device, into account when calculating a remaining power capacity. An environmental parameter can particularly be a shaft or a cabin temperature of the elevator, or an air humidity in the shaft or in the cabin. In some embodiments, the power storage device might display a greater remaining power capacity at first temperature and a lower remaining power capacity at a second, different temperature.

According to an embodiment for facilitating the learning system and/or becoming independent of generating sensor values, the remaining power supply capacity and/or the power demand is determined using at least one operational model, particularly a characteristic diagram.

Such an operational model can particularly comprise various values of a remaining power capacity of a storage device, each linked to a different combination of charge levels, degradation levels and/or temperature levels of the energy storage device. Such an operational model can particularly comprise various values of power demand of an electrical consumer, each linked to a different combination of operational status and/or environmental/operational parameters of the electrical consumer.

According to an embodiment, the emergency power supply comprises an information interface, which is configured to visually, textually and/or audibly inform a maintenance technician of a result of a comparison of the predicted period of time and a predetermined time period threshold. In an exemplary embodiment, the information interface can be an LED or an LED display in the cabin in combination with suitable lighting or text pattern, and/or can be speakers in combination with suitable sounds or voice generation.

Additionally or alternatively, the information interface can comprise a remote connection and be displayed, for example, on a screen at a maintenance facility of the elevator's operation or maintenance provider. Particularly, the emergency power supply comprises a communication device, which is configured to remotely inform a maintenance facility of a result of a comparison of the predicted period of time and a predetermined time period threshold, via a suitable remote communication standard (e.g. Wifi, Bluetooth, Cloud access, etc.). According to an embodiment, this information can be sent to a maintenance technician's personal device using the communication device.

According to an embodiment, the control unit comprises and/or is configured to access at least one operational model, particularly a characteristic diagram, in which different predicted remaining power supply capacities and/or different power demands are linked to at least one or a combination of at least one value of: a) an operating status of an electrical consumer in the elevator cabin, and/or b) an environmental parameter of the elevator cabin, and/or c) a charge level of the energy storage device, and/or d) a degradation parameter of the energy storage device.

Further advantages and applications of the invention result from the description below referring to the figures.

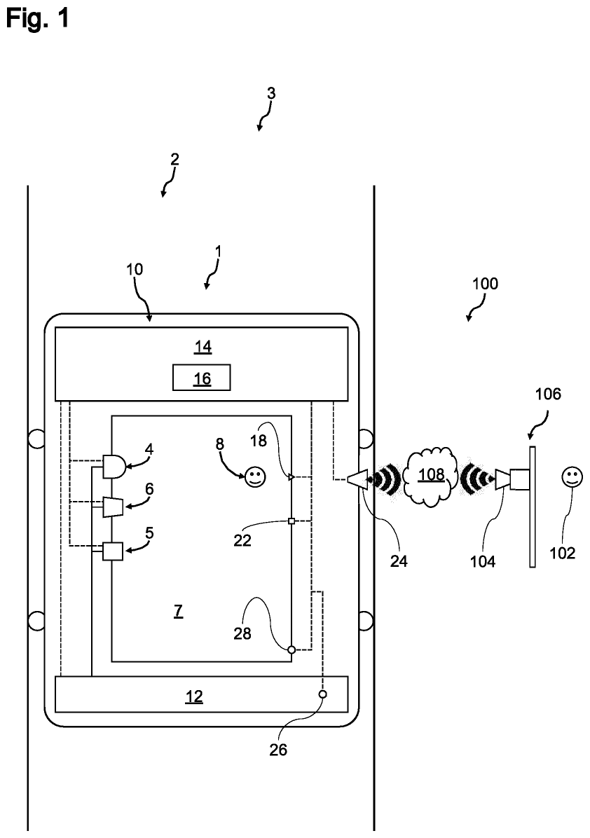

FIG. 1 shows an elevator cabin comprising an emergency power supply according to an exemplary embodiment of the invention, in a schematic view.

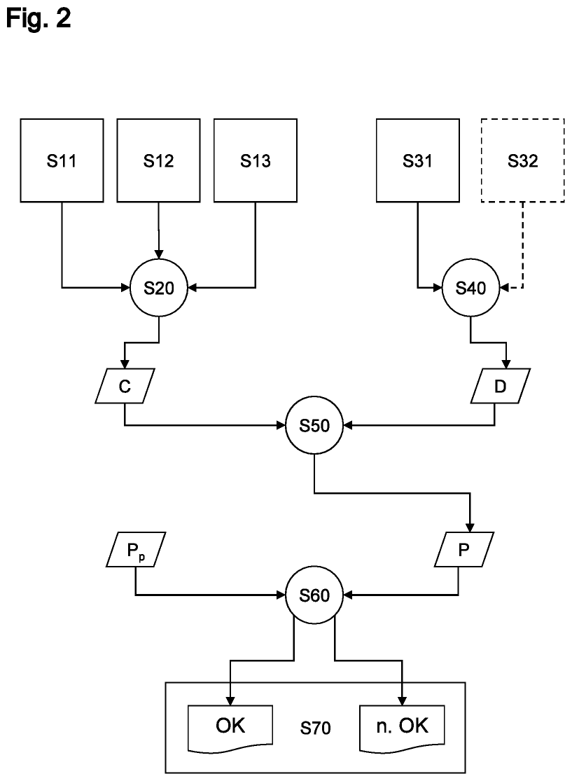

FIG. 2 shows a block diagram of a method of operating the emergency power supply of FIG. 1 according to an exemplary embodiment of the invention.

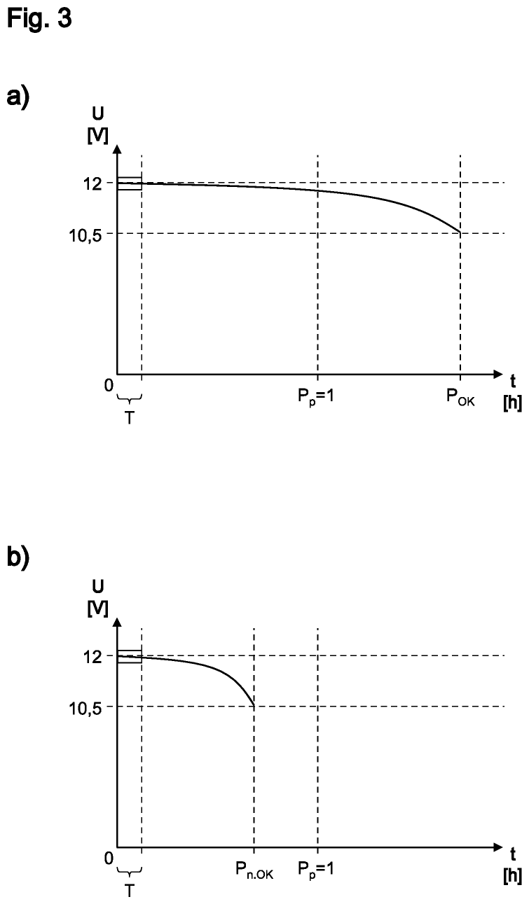

FIGS. 3a and 3b show diagrams representative of different possible outcomes of performing the method of FIG. 2 on an emergency power supply according to FIG. 1.

In FIG. 1, an elevator cabin 1 for transporting passengers along an elevator shaft 2 of an elevator 3. The elevator cabin 1 comprises several electrical consumers 4, 5 and 6, which are exemplary depicted as a bulb of a lighting fixture 4, a microphone/speaker combination of an emergency communication device 5 and a nozzle of an air conditioning 6. The electrical consumers 4, 5 and 6 are arranged in a cabin interior 7 of the elevator cabin 1, particularly at a side wall of the cabin interior 7.

The elevator cabin 1 comprises an emergency power supply 10 according to an exemplary embodiment of the invention, which is configured to provide power to the electrical consumers during a failure of the elevator main power supply. Emergency power supply 10 is configured to run a test method according to an exemplary embodiment depicted in FIG. 2.

The emergency power supply 10 comprises an energy storage device 12 which is at least one, preferably rechargeable, battery. The energy storage device 12 can be electrically connected to the electrical consumers 4, 5 and 6 (see continuous lines in FIG. 1), to supply power in case of a main power failure.

Furthermore, the emergency power supply 10 comprises a control unit 14, which is configured to operate the energy storage device 12. The control unit 14 comprises and/or has access to an operational model 16, which exemplary comprises several characteristic diagrams, linking different predicted remaining power supply capacities C of the energy storage device 12 and/or different power demands D of the electrical consumers 4, 5, 6 to different combinations of values of various parameters.

The emergency power supply 10 furthermore comprises an information interface 18 having an LED or a display, a test trigger button 22, and a communication device 24 for remote communication with maintenance staff and/or a maintenance facility 102. Energy power supply 10 also comprises a first temperature sensor 26 for measuring a temperature of the energy storage device 12 and a second temperature sensor 28 for measuring a temperature of the cabin interior 7.

Lighting fixture 4, emergency communication device 5, air conditioning 6, energy storage device 12, information interface 18, test trigger button 22, communication device 24 and temperature sensors 26 and 28 are connected to control unit 14 for data exchange (see dotted lines in FIG. 1).

FIG. 1 also shows an emergency power supply system 100, comprising the emergency power supply 10 as well as the necessary infrastructure for starting a test method according to FIG. 2 or other exemplary embodiments of a method according to the invention, and for receiving the test results. Such infrastructure exemplary comprises a communication device 104 and a computer 106 for starting the test method and displaying the results in a maintenance facility 102 which may also remotely trigger the test.

Particularly, the test can also be started by and the results can also be transmitted to a mobile communication device of maintenance staff 8, particularly by a direct transfer (via cloud, blue tooth, 3G, etc.) or an intedirect transfer after the data passes through the maintenance facility.

Communication between communication devices 24 and 104 can exemplary be established via a cloud-based service 108, for example Microsoft Azure, deploying a communication standard of an Ethernet, WiFi, Bluetooth, G3, G4, G5 or similar type.

Emergency power supply 10 is configured to run a test method according to an exemplary embodiment invention, aiming at predicting whether energy storage device 12 will be able to provide sufficient emergency power to electrical consumers 4, 5 and 6 during a predetermined time period threshold Pₚ (predetermined by standardization requirements). Detailed steps of the exemplary method will be described below with respect to FIGS. 2 and 3.

FIG. 2 shows a block diagram of steps S10 to S70 performed during testing the energy storage device's 12 capability to provide sufficient emergency power long enough.

In step S10, a maintenance technician 8 hits the trigger button 22 to start the test procedure according to the exemplary method. This trigger activates control unit 14 for carrying out the steps described below.

In step S11, a charge level of the energy storage device 12 is determined, particularly by accessing a battery management system (not shown in FIG. 1) and/or the operational model 16. Thus, a measure of the energy amount contained in the battery can be derived.

In step S12, a degradation level of the energy storage device 12 is determined, particularly by accessing a battery management system and/or the operational model 16. Thus, a measure of the energy amount and supply speed from the battery can be derived.

In step S13, a current temperature of the energy storage device 12 is determined, particularly taking values of temperature sensor 26 into account. Thus, certain temperature-based limitations of a battery operation can be derived for especially high or low temperatures.

Based on the measures determined in steps S11, S12 and S13, a remaining power supply capacity C of the energy storage device 12 of the emergency power supply 10 is determined in step S20.

In the exemplary embodiment of FIG. 2, the remaining power supply capacity C can be derived in various suitable forms. Exemplary, a remaining capacity C of the battery 12 in ampere-hours and/or a remaining time in which the energy storage device 12 will be able to provide more than a threshold current can be determined.

In step S31, a present power consumption of the electrical consumers 4, 5 and 6 is measured during a test interval. In an optional step S32, a development of the power consumption of electrical consumers 4, 5 and 6 during the test interval can be measured.

In an exemplary embodiment, an operational status (e.g. on/off) is determined and linked to a power consumption deposited in operational model 16 for the present status, optionally depending on a temperature measured in cabin interior 7 by temperature sensor 28.

From the steps S31 and S32, a present and/or average and/or power demand D of the electrical consumers 4, 5 and 6 is determined in step S40.

In an exemplary embodiment, the single power demands determined for the different electrical consumers 4, 5 and/or 6 are combined for determining overall power demand D in step S40, particularly stating an overall current supply required by the consumers 4, 5 and 6. The determined power demand D particularly can be a constant value or described by a suitable function over time.

In step S50, a period of time P for the capability of the energy storage device 12 to provide the electrical consumers 4, 5 and 6 with sufficient power is predicted, particularly by comparing the remaining supply power capacity C determined in step 20 and the overall power demand D determined in step S40. For example, the remaining capacity C has been determined in ampere-hours (Ah) and the overall power demand D has been determined in amperes (A), the period of time can be calculated via the fraction: P=C/D.

By a comparison (step S60) with a predetermined time period threshold Pₚ, an information on whether energy storage device 12 can support electrical consumers 4, 5 and 6 long enough for meeting a standardization requirement can be obtained as a test result.

This information is provided in step S70. For a case in which a maintenance technician 8 is present in the cabin 7, the LED of information interface 18—for example—intermittently flashes in case requirements are not met (reference sign “n. OK”) and continually shines in case requirements are met (reference sign “OK”).

For a case in which test results are to be transmitted to a remote maintenance facility 102, a detailed test report is transmitted via communication devices 24, cloud-based service 108 and communication device 104 to computer 106. For a case in which test results are to be transmitted to a mobile device of maintenance technician 8, a detailed test report is transmitted via communication device 24, particularly using a Bluetooth or Wi-Fi connection.

In FIG. 3a, a diagram representative of a positive outcome of the test according to FIG. 2 is shown. The diagram shows a predicted battery voltage over time and also illustrates the test interval T.

The data presented in this diagram has been derived by the control unit 10 accessing operational model 16 for a deposited correlation between remaining capacity of energy storage device 12, overall power consumption of electrical consumers 4, 5 and 6, and remaining battery voltage.

FIG. 3a shows a case in which battery 12 is predicted to provide more than a threshold voltage of 10.5 Volts for a period of time P_{OK} longer than the required time period threshold Pₚ of one hour. In this case, energy storage device 12 can still be deployed, at least until the next scheduled inspection.

FIG. 3b shows a case in which battery 12 it is predicted to cease providing more than the threshold voltage after a period of time P_{n.OK} before the required time period threshold Pₚ of one hour has passed by. In this case, energy storage device 12 must be changed to fulfil the standardization requirement.

### List of Reference Signs

1 elevator cabin

2 elevator shaft

3 elevator

4, 5, 6 electrical consumers (lighting fixture 4, emergency communication device 5, air conditioning 6)

7 cabin interior

8 maintenance technician

10 emergency power supply

12 energy storage device

14 control unit

16 operational model

18 information interface

22 tests trigger button

24 communication device

26 first temperature sensor

28 second temperature sensor

100 emergency power supply system

102 maintenance facility

104 communication device

106 desktop computer

108 cloud-based service

C remaining power supply capacity of the energy storage device

D power demand of the electrical consumers

n.OK positive test result

n.OK negative test result

P period of time

Pₚ predetermined time period

S10-S70 method steps

T test time interval

1.-15. (canceled)

16. A method of operating an emergency power supply for an elevator cabin, comprising:
determining a remaining power supply capacity of an energy storage device of the emergency power supply;
determining a power demand of at least one electrical consumer in the elevator cabin; and
predicting a period of time in which the energy storage device is capable of providing the electrical consumer with power, based on the determined remaining power supply capacity and the determined power demand.

17. The method of claim 16, further comprising:
comparing the predicted period of time to a predetermined time period threshold.

18. The method of claim 17, further comprising:
providing in the elevator cabin, and/or to a maintenance facility, information representative of the result of the comparing step.

19. The method of claim 17, wherein the information provided indicates that the time period threshold exceeds the predicted period of time and is presented in the form of one or more of a visual, sound, or text-based message.

20. The method of claim 16, wherein the power demand is determined based on at least one of a power consumption or a development of the power consumption of the electrical consumer during a test interval.

21. The method of claim 16, wherein the power demand is determined based on at least one value of at least one environmental parameter of the elevator cabin.

22. The method of claim 16, wherein the remaining power supply capacity is determined based on at least one of:
a value of a parameter representative of a charge level of the energy storage device;
a value of a degradation parameter of the energy storage device; or a value of an environmental parameter of the elevator cabin.

23. The method of claim 16, wherein at least one of the remaining power supply capacity or the power demand is determined based on at least one operational model.

24. An emergency power supply for an elevator cabin, comprising:
an energy storage device configured to provide power to an electrical consumer during a failure of an elevator main power supply; and
a control unit configured to:
control operation of the energy storage device,
determine a remaining power supply capacity of the energy storage device,
determine a power demand of the electrical consumer, and
predict a period of time in which the energy storage device is capable of providing the electrical consumer with power, based on the determined remaining power supply capacity and the determined power demand.

25. The emergency power supply of claim 24, wherein said control unit is further configured to compare the predicted period of time to a predetermined time period threshold, the emergency power supply further comprising:
an information interface configured to visually, textually, and/or audibly inform a maintenance technician of a result of a comparison of the predicted period of time and a predetermined time period threshold.

26. The emergency power supply of claim 25, further comprising:
a communication device configured to remotely inform a maintenance facility of a result of a comparison of the predicted period of time and a predetermined time period threshold.

27. The emergency power supply of claim 24, wherein said control unit is configured to access at least one operational model in which different predicted remaining power supply capacities and/or different power demands are linked to at least one of:
an operating status of an electrical consumer in the elevator cabin,
an environmental parameter of the elevator cabin,
a charge level of the energy storage device, or
a degradation parameter of the energy storage device.

28. An elevator system, comprising:
an elevator cabin configured to be moved within an elevator shaft;
an emergency power supply configured to supply emergency power to at least one electrical consumer in said elevator cabin, said emergency power supply having:
an energy storage device configured to provide power to the electrical consumer during a failure of an elevator main power supply, and
a control unit configured to control operation of the energy storage device, determine a remaining power supply capacity of the energy storage device, determine a power demand of the electrical consumer, and predict a period of time in which the energy storage device is capable of providing the electrical consumer with power, based on the determined remaining power supply capacity and the determined power demand.

29. The elevator system of claim 28, further comprising:
an electrical consumer.

30. The elevator system of claim 29, wherein said electrical consumer is one of a cabin light, an emergency communication device, or an emergency air conditioner.
